(19) United States
(12) Patent Application Publication
(10) Pub. No.: US 2021/0088865 A1
(43) Pub. Date: Mar. 25, 2021

(54) ELECTROCHROMIC DEVICE AND METHOD FOR FABRICATING THE SAME

(71) Applicant: Institute of Nuclear Energy Research, Atomic Energy Council, Executive Yuan, R.O.C, Taoyuan (TW)

(72) Inventors: TIEN-FU KO, Taoyuan (TW); CHEN-TE CHANG, Taoyuan (TW); PO-WEN CHEN, Taoyuan (TW); HSIN-FU YU, Taoyuan (TW); KUO-CHUAN HO, Taoyuan (TW); SHENG-CHUAN HSU, Taoyuan (TW); JIN-YU WU, Taoyuan (TW); WEN-FA TSAI, Taoyuan (TW); HWEN-FEN HONG, Taoyuan (TW)

(21) Appl. No.: 16/728,137

(22) Filed: Dec. 27, 2019

(30) Foreign Application Priority Data
Sep. 24, 2019 (TW) 108134401

(51) Int. Cl. G02F 1/155; G02F 1/1524; E06B 9/24

(52) U.S. Cl. CPC G02F 1/155; E06B 2009/2464; E06B 9/24; G02F 1/1524

(57) ABSTRACT

A method for fabricating an electrochromic device includes: depositing a first transparent film on a first substrate; depositing a first mesh structure on the first transparent film; depositing a second transparent film on the first mesh structure; depositing an electrochromic layer of WO₃ or MoO₃ on the second transparent film by an arc-plasma process to form a first electrode structure; depositing a third transparent film on a second substrate; depositing a second mesh structure on the third transparent film; depositing a fourth transparent film on the second mesh structure; forming an ion storage layer of PB on the fourth transparent film to produce a second electrode structure; binding the first and second electrode structures by having the electrochromic layer to face the ion storage layer; and, forming an electrolyte layer between the first and second electrode structures to produce the electrochromic device. In addition, an electrochromic device is also provided.

### CROSS REFERENCE TO RELATED APPLICATION

This application claims the benefits of Taiwan application Serial No. 108134401, filed on Sep. 24, 2019, the disclosures of which are incorporated by references herein in its entirety.

### TECHNICAL FIELD

The present disclosure relates in general to an electrochromic device and a method for fabricating the same electrochromic device.

### BACKGROUND

Electrochromism is the phenomenon where the color or opacity of a material changes caused by occurrence of new absorption peaks within visible light ranges while the material is experiencing electron transfer or redox (oxidation-reduction) reactions. Such phenomenon is reversible. In other words, the color of the material can be resumed after the material is further applied by another voltage. Since the electrochromic device consumes less electricity, thus can be applied to smart windows for absorbing sunshine, anti-glare rearview mirrors, vehicle sunroofs, electronic papers and so on. Namely, the electrochromic device can be suitable for commercial constructions, residence/office buildings, intelligent homes and the like.

Currently, the electrochromic device is manufactured mostly by expensive magnetron plasma splutters. Since the manufacturing process takes extensive labor time, thus production cost is significantly increased, and product prices can't be reduced. Thereby, the electrochromic device cannot be widely applied for the commercial constructions, residence/office buildings, intelligent homes and the like, and thus the market share thereof would be poor.

Hence, an improvement upon the electrochromic device and the method for fabricating the electrochromic device for resolving the aforesaid shortcomings is definitely urgent and welcome to the skill persons in the art.

### SUMMARY

An object of the present disclosure is to provide an electrochromic device and a method for fabricating the same electrochromic device, that can reduce process time and production cost, and that can enhance entire performance of the electrochromic device.

In this disclosure, the method for fabricating an electrochromic device includes: a step (a) of depositing a first transparent conductive film on a first substrate; a step (b) of depositing a first mesh conductive structure on the first transparent conductive film; a step (c) of depositing a second transparent conductive film on the first mesh conductive structure; a step (d) of depositing an electrochromic layer on the second transparent conductive film by an arc-plasma process to form a first electrode structure, the electrochromic layer being made of one of WO₃ and MoO₃; a step (e) of depositing a third transparent conductive film on a second substrate; a step (f) depositing a second mesh conductive structure on the third transparent conductive film; a step (g) of depositing a fourth transparent conductive film on the second mesh conductive structure; a step (h) of forming an ion storage layer on the fourth transparent conductive film to produce a second electrode structure, the ion storage layer being made of Prussian blue; a step (i) of binding together the first electrode structure and the second electrode structure by having the electrochromic layer of the first electrode structure to match the ion storage layer of the second electrode structure; and, a step (j) of forming an electrolyte layer between the electrochromic layer and the ion storage layer so as to produce the electrochromic device.

In one embodiment of this disclosure, the step (b) includes a step (b1) of providing a metal mask onto the first transparent conductive film, the metal mask having a plurality of opening structures; and, a step (b2) of spluttering the metal material onto the metal mask and the first transparent conductive film so as to deposit the metal material into the opening structures for forming the first mesh conductive structure.

In one embodiment of this disclosure, the step (f) includes a step (f1) of providing a metal mask onto the third transparent conductive film, the metal mask having a plurality of opening structures; and, a step (f2) of spluttering the metal material onto the metal mask and the third transparent conductive film so as to deposit the metal material into the opening structures for forming the second mesh conductive structure.

In one embodiment of this disclosure, the step (h) includes a step (h1) of applying a spin coating process to coat a material of the ion storage layer over the fourth transparent conductive film.

In one embodiment of this disclosure, the step (i) includes a step (i1) of turning the first electrode structure upside down so as to have the electrochromic layer of the first electrode structure to face the ion storage layer of the second electrode structure.

In one embodiment of this disclosure, the step (j) includes a step (j1) of binding together the electrochromic layer of the first electrode structure and the ion storage layer of the second electrode structure by producing a fill-up space between the electrochromic layer and the ion storage layer; and, a step (j2) of filling an electrolyte substance into the fill-up space so as to form the electrolyte layer.

In another aspect of this disclosure, an electrochromic device includes a first electrode structure, a second electrode structure and a electrolyte layer. The first electrode structure includes a first substrate, a first transparent conductive film, a first mesh conductive structure, a second transparent conductive film and an electrochromic layer. The first transparent conductive film is disposed between the first substrate and the first mesh conductive structure, the first mesh conductive structure is disposed between the first transparent conductive film and the second transparent conductive film, the second transparent conductive film is disposed between the first mesh conductive structure and the electrochromic layer, the first mesh conductive structure includes a plurality of first conductive wires is disposed between the first transparent conductive film and the second transparent conductive film, the electrochromic layer is disposed on the second transparent conductive film, and the electrochromic layer is made of WO₃ or MoO₃. The second electrode structure, includes a second substrate, a third transparent conductive film, a second mesh conductive structure, a fourth transparent conductive film and a ion storage layer. The third transparent conductive film is disposed between the second substrate and the second mesh conductive structure, the second mesh conductive structure is disposed between the third transparent conductive film and the fourth transparent conductive film, the fourth transparent conductive film is disposed between the second mesh conductive structure and the ion storage layer, and the ion storage layer is made of Prussian blue. The electrolyte layer is disposed between the electrochromic layer of the first electrode structure and the ion storage layer of the second electrode structure.

In one embodiment of this disclosure, the first conductive wire is made of silver.

In one embodiment of this disclosure, the first mesh conductive structure includes a mesh structure formed by arranging the plurality of first conductive wires.

In one embodiment of this disclosure, the second conductive wire is made of silver.

In one embodiment of this disclosure, the second mesh conductive structure includes a mesh structure forming by arranging the plurality of second conductive wires.

As stated, the electrochromic device and the method for fabricating the same electrochromic device provided by this disclosure, which apply the arc-plasma process to deposit the electrodes of the electrochromic layers, can reduce both the process time and production cost, strengthen the voltage endurance, have better color-changing efficiency, and extend the service life.

Further, the Prussian blue (PB) adopted in this disclosure is used for the electrochromic anode material, in which Prussian blue (PB) matches well withvWO₃ or MoO₃ in the electrochromic cathode material of the electrochromic layer so as to achieve better optical performance, higher coloring efficiency and a rapid response rate.

In addition, the transparent conductive layer of this disclosure is formed by a three-layer lamination structure having upper and lower transparent conductive films to sandwich a mesh conductive structure. The mesh conductive structure is formed by a plurality of silver-made conductive wires arranged into a specific pattern. Through the conductive wires, the electrode transmission can be performed. Since these conductive wires do not occupy the entire space between the upper and the lower transparent conductive films. In other words, the conductive wires do not utilize the entire area for transmission, but utilize the aforesaid small transmission units formed by arranging the conductive wires. Thereupon, the unexpected high transverse impedance of the electron transport layer (i.e., the transparent conductive layer) can be resolved, and also shortcomings in uneven color-changing and elongated reaction time during the transmission at the entire transparent conductive layer can be substantially improved.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the electrochromic device in accordance with this disclosure;

FIG. 2 is a flowchart of an embodiment of the method for fabricating an electrochromic device in accordance with this disclosure;

FIG. 3A through FIG. 3I demonstrate illustratively individual steps of the method of FIG. 2 for fabricating the electrochromic device of FIG. 1;

FIG. 4 demonstrates schematically a metal mask placed on the first transparent conductive film in accordance with this disclosure; and

FIG. 5 illustrates schematically the mesh structure of the first conductive wires in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

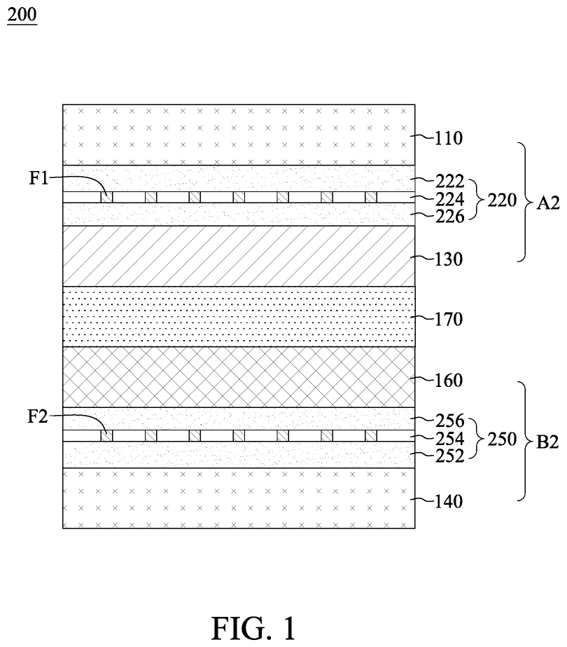

Referring now to FIG. 1, a schematic view of an embodiment of the electrochromic device in accordance with this disclosure is illustrated. As shown, in this embodiment, the electrochromic device 200, as a complementary electrochromic device, includes a first electrode structure A2, a second electrode structure B2 and a electrolyte layer 170; in which the first electrode structure A2 serves as a cathode electrode, the second electrode structure B2 serves as an anode electrode, and the electrolyte layer 170 is located between the first electrode structure A2 and the second electrode structure B2.

In this embodiment, the first electrode structure A2 includes a first substrate 110, a first transparent conductive film 222, a first mesh conductive structure 224, a second transparent conductive film 226 and an electrochromic layer 130. The first substrate 110 can be made of glass. The first transparent conductive film 222 is disposed between the first substrate 110 and the first mesh conductive structure 224. The first mesh conductive structure 224 is disposed between the first transparent conductive film 222 and the second transparent conductive film 226. The second transparent conductive film 226 is disposed between the first mesh conductive structure 224 and the electrochromic layer 130.

In this embodiment, a transparent conductive electrode layer 220 is formed by laminating orderly the first transparent conductive film 222, the first mesh conductive structure 224 and the second transparent conductive film 226. Each of the first transparent conductive film 222 and the second transparent conductive film 226 can be made of indium tin oxide (ITO). The first mesh conductive structure 224 includes thereinside a plurality of first conductive wires F1 arranged between the first transparent conductive film 222 and the second transparent conductive film 226. In addition, an electrochromic cathode material inside the electrochromic layer 130 is selected from one of WO₃ and MoO₃.

In this embodiment, the first conductive wire F1 can be made of silver, and thus the first conductive wire F1 can be used for electrode transmission. In addition, the first conductive wires F1 don't fill all the space between the first transparent conductive film 222 and the second transparent conductive film 226. In other words, the first conductive wires F1 don't utilize all the aforesaid space for transmission, but the first conductive wires F1 are arranged for form a plurality of transmission units, as shown in FIG. 5. In this embodiment, the first conductive wires F1 are arranged into a mesh structure having a plurality of the small transmission units, such that, besides the hard-to-be-reduced transverse impedance at the electron transport layer (such as the first transparent conductive film 222, the first mesh conductive structure 224 or the second transparent conductive film 226 of the transparent conductive electrode layer 220) can be resolved, uneven coloring and slow response caused by transmission over the entire transparent conductive electrode layer 220 can be improved.

In this embodiment, the second electrode structure B2 includes the second substrate 140, the third transparent conductive film 252, the second mesh conductive structure 254, the fourth transparent conductive film 256 and the ion storage layer 160. The second substrate 140 can be made of glass. The third transparent conductive film 252 is disposed between the second substrate 140 and the second mesh conductive structure 254. The second mesh conductive structure 254 is disposed between the third transparent conductive film 252 and the fourth transparent conductive film 256. The fourth transparent conductive film 256 is disposed between the second mesh conductive structure 254 and the ion storage layer 160.

In this embodiment, a transparent conductive electrode layer 250 is formed by laminating orderly the third transparent conductive film 252, the second mesh conductive structure 254 and the fourth transparent conductive film 256. Each of the third transparent conductive film 252 and the fourth transparent conductive film 256 can be made of ITO, the second mesh conductive structure 254 includes thereinside a plurality of second conductive wires F2 arranged between the third transparent conductive film 252 and the fourth transparent conductive film 256. In this embodiment, the second conductive wire F2 is made of silver, and thus the second conductive wire F2 can be used for electrode transmission. In addition, the second conductive wires F2 don't fill all the space between the third transparent conductive film 252 and the fourth transparent conductive film 256. In other words, the second conductive wires F2 don't utilize all the aforesaid space for transmission, but the second conductive wires F2 are arranged for form a plurality of transmission units, as shown in FIG. 5. In this embodiment, the second conductive wires F1 are arranged into a mesh structure having a plurality of the small transmission units, such that, besides the hard-to-be-reduced transverse impedance at the electron transport layer (such as the transparent conductive electrode layer 250) can be resolved, uneven coloring and slow response caused by transmission over the entire transparent conductive electrode layer 250 can be improved.

In addition, the ion storage layer 160, having a function for storing ions, is to provide ions during the color-changing process, and an electrochromic anode material of the ion storage layer 160 is Prussian blue. In this embodiment, besides the electrochromic layer 130, the ion storage layer 160 can serve another electrochromic film. Therefore, two different color-changeable materials can be used purposely for the electrochromic layer 130 and the ion storage layer 160 to serve the electrochromic cathode material and the electrochromic anode material, respectively. By setting the electrochromic layer 130 as the transparent end and the ion storage layer 160 as the color end, then by applying positive and negative voltages, the transparent end would enter a color state, and the color end would be decolored or desaturated to enter the transparent state; i.e., a complementary electrochromic device is formed.

In this embodiment, the electrolyte layer 170 is disposed between the electrochromic layer 130 of the first electrode structure A2 and the ion storage layer 160 of the second electrode structure B2, in which the electrolyte layer 170 contains a material of LiClO₄—PC.

Under such an arrangement of this embodiment, the electrochromic device 200 can deposit the electrochromic layer 130 by an arc-plasma process. Thus, the voltage endurance can be strengthened, better color-changing performance can be provided, and the service life can be substantially extended. In addition, the electrochromic anode material can be made of Prussian blue (PB), which can match well with the WO₃ or MoO₃ in the electrochromic cathode material of the electrochromic layer 130, and so better optical properties, excellent coloring efficiency and rapid action response can be obtained.

In addition, the transparent conductive layer of this embodiment is formed by a three-layer lamination structure having upper and lower transparent conductive films to sandwich a mesh conductive structure. The mesh conductive structure is formed by a plurality of silver-made conductive wires arranged into a specific pattern. Through the conductive wires, the electrode transmission can be performed. Since these conductive wires do not occupy the entire space between the upper and the lower transparent conductive films. In other words, the conductive wires do not utilize the entire area for transmission, but utilize the aforesaid small transmission units formed by arranging the conductive wires. Thereupon, the unexpected high transverse impedance of the electron transport layer (i.e., the transparent conductive layer) can be resolved, and also shortcomings in uneven color-changing and elongated reaction time during the transmission at the entire transparent conductive layer can be substantially improved.

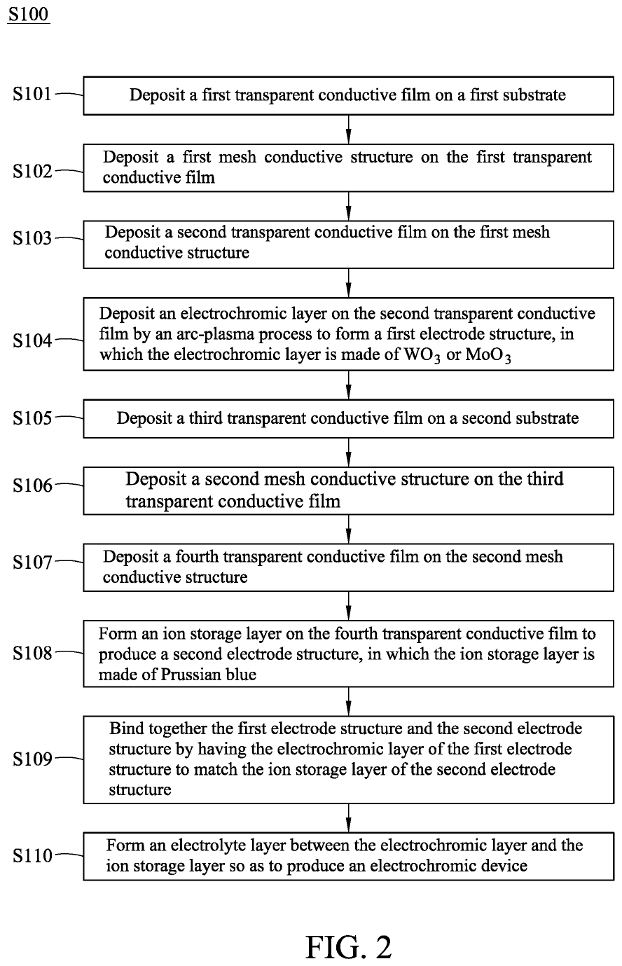

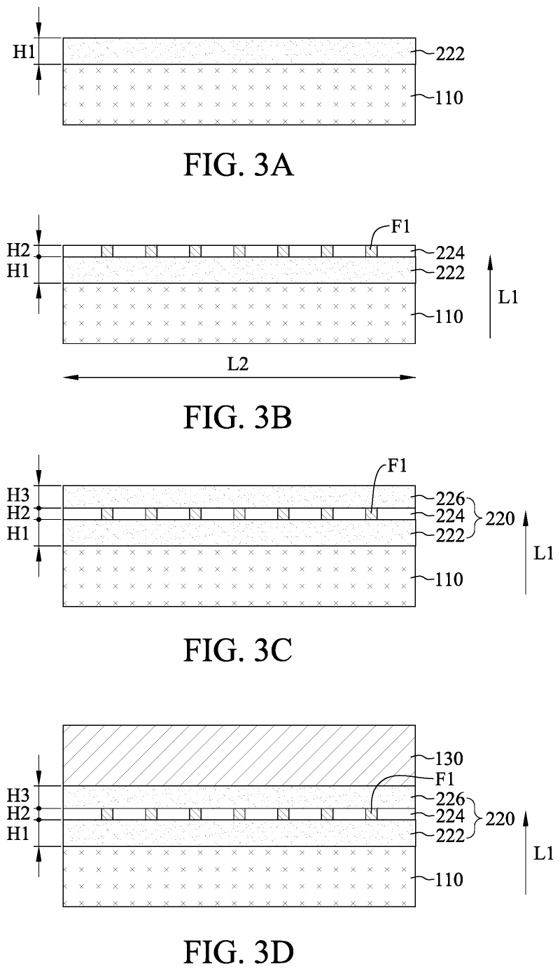

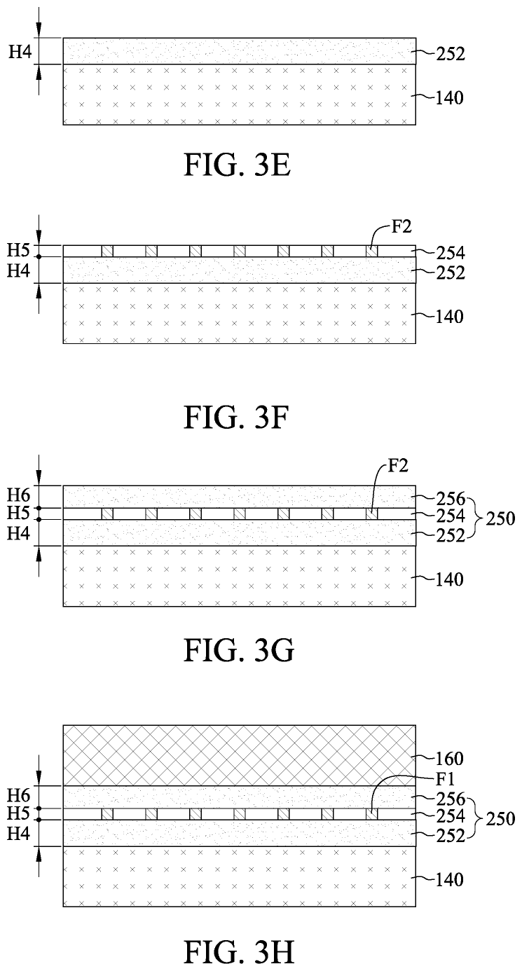

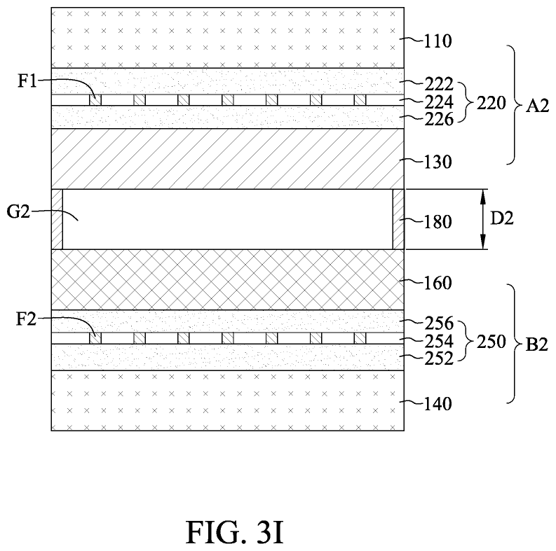

Refer now to FIG. 2 through FIG. 3I; where FIG. 2 is a flowchart of an embodiment of the method for fabricating an electrochromic device in accordance with this disclosure, and FIG. 3A through FIG. 3I demonstrate illustratively individual steps of the method of FIG. 2 for fabricating the electrochromic device of FIG. 1. As shown in FIG. 2, the embodiment of the method for fabricating an electrochromic device S100 includes Step S101 to Step S110 as follows.

Firstly, Step S101 is performed to deposit a first transparent conductive film 222 on a first substrate 110, as shown in FIG. 3A. The first substrate 110 can be made of glass, and the first transparent conductive film 222 is made of ITO. In detailing this step, firstly place the first substrate 110 into a spluttering process chamber, then vacuum the spluttering process chamber to a pressure under 8×10⁻⁶ torr in the spluttering process chamber, introduce Argon into the spluttering process chamber in a vacuum state, and then a spluttering process is applied to deposit the first transparent conductive film 222 onto the first substrate 110, in which a thickness H1 of the first transparent conductive film 222 is about 300 nm.

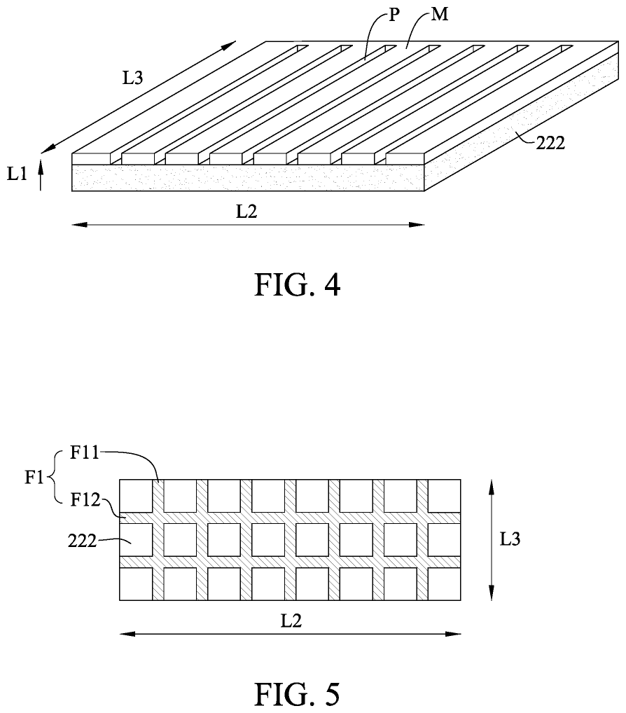

In this embodiment, after the first transparent conductive film 222 is formed onto the first substrate 110, Step S102 is performed to deposit a first mesh conductive structure 224 on the first transparent conductive film 222, as shown in FIG. 3B. In detailing this step, firstly, as shown in FIG. 4, a metal mask M is provided onto the first transparent conductive film 222. The metal mask M is disposed on the first transparent conductive film 222 along the thickness direction L1. The shape and dimension of the metal mask M is not specifically limited, but determined and adjusted in accordance with the practical shape and dimension of the first transparent conductive film 222.

In this embodiment, the metal mask M has a plurality of opening structures P, and each of the opening structures P is formed as a slot structure. The slot structures are arranged in parallel but perpendicular to the first direction L2. An interval for arranging the opening structures P is determined according to the practical arrangement of the conductive wires. Then, a metal material is sputtered onto the metal mask M and the first transparent conductive film 222 so as to allow the metal material to deposit into the opening structures P, such that the first conductive wires F1 can be formed on the first mesh conductive structure 224, as shown in FIG. 3B. In this embodiment, a thickness H2 of the first mesh conductive structure 224 is about 20-50 nm.

For example, the metal mask M is firstly applied to plate a first layer of the conductive wires F11, as shown in FIG. 5, in which the conductive wires F11 are arranged in parallel and perpendicular to the first direction L2. Then, the metal mask M is rotated by 90° so as to arrange the parallel opening structures P to be perpendicular to the second direction L3, and thus a second layer of the conductive wires F12 is formed by plating, in which the conductive wires F12 are arranged in parallel and perpendicular to the second direction L3. With the conductive wires F11 arranged perpendicular to the conductive wires F12, the first conductive wires F1 are thus formed as a mesh structure. However, in this disclosure, formulation of the first conductive wires F1 is not limited to the aforesaid arrangement. In an embodiment not shown herein, the metal mask can be designed to have the opening structures P to be arranged directly into the mesh structure, so that the first conductive wires F1 can be directly plated as the mesh structure.

In this embodiment, after the first mesh conductive structure 224 is formed on the first transparent conductive film 222 in the thickness direction L1, then Step S103 is performed to deposit a second transparent conductive film 226 on the first mesh conductive structure 224, as shown in FIG. 3C. In detailing this step, firstly the first substrate 110, the first transparent conductive film 222 and the first mesh conductive structure 224 as a whole are placed into the spluttering process chamber, then the spluttering process chamber is vacuumed to a degree of vacuum below 8×10⁻⁶ torr, Argon is introduced into the spluttering process chamber in the vacuum state, and finally a spluttering process is applied to deposit the second transparent conductive film 226 onto the first mesh conductive structure 224. In this embodiment, a thickness H3 of the second transparent conductive film 226 is about 300 nm.

In this embodiment, the second transparent conductive film 226 is formed on the first mesh conductive structure 224, i.e., arranged in the thickness direction L. After the second transparent conductive film 226 is deposed on the first mesh conductive structure 224, then Step S104 is performed to deposit an electrochromic layer 130 on the second transparent conductive film 226 (as shown in FIG. 3D) in a gas mixture of oxygen and Argon by an arc-plasma process to form a first electrode structure A2 of FIG. 1, in which the electrochromic layer 130 is made of WO₃, MoO₃ or the like metal oxide. In this embodiment, a thickness of the electrochromic layer 130 is about 175-200 nm.

After the first electrode structure A2 is formed, as shown in FIG. 4, then Step S105 is performed to deposit a third transparent conductive film 252 on a second substrate 140 (as shown in FIG. 3E). The second substrate 140 can be made of glass, and the third transparent conductive film 252 can be made of ITO. In detailing this step, firstly the second substrate 140 is placed into the spluttering process chamber, then the spluttering process chamber is vacuumed to a degree of vacuum under 8×10⁻⁶ torr, Argon is introduced into the spluttering process chamber in the vacuum state, and finally the spluttering process is applied to deposit the third transparent conductive film 252 onto the second substrate 140. In this embodiment, a thickness H4 of the third transparent conductive film 252 is about 300 nm.

In this embodiment, after the third transparent conductive film 252 is formed on the second substrate 140, then Step S106 is performed to deposit a second mesh conductive structure 254 on the third transparent conductive film 252. The process for spluttering the second mesh conductive structure 254 is similar to that for spluttering the first mesh conductive structure 224. Firstly, the metal mask M having a plurality of opening structures P is provided onto the third transparent conductive film 254. Then, a metal material is spluttered onto the metal mask M and the third transparent conductive film 254 so as to have the metal material to deposit inside the opening structures P for forming the second mesh conductive structure 254. Namely, through the metal mask M and the opening structures P, the second conductive wires F2 of the second mesh conductive structure 254 is formed, as shown in FIG. 3F. In this embodiment, a thickness H5 of the second mesh conductive structure 254 is about 20-50 nm, and the mesh structure formed by the second conductive wire F2 is shown in FIG. 5 structure.

In this embodiment, after the second mesh conductive structure 254 is formed on the third transparent conductive film 252, then Step S107 is performed to deposit a fourth transparent conductive film 256 on the second mesh conductive structure 254, as shown in FIG. 3G. The fourth transparent conductive film 256 can be made of ITO. In detailing this step, firstly the second substrate 140, the third transparent conductive film 252 and the second mesh conductive structure 254 as a whole are placed into the spluttering process chamber, then the spluttering process chamber is vacuumed to a degree of vacuum under 8×10⁻⁶ torr, Argon is introduced into the spluttering process chamber in the vacuum state, and finally the spluttering process is applied to deposit the fourth transparent conductive film 256 onto the second mesh conductive structure 254. In this embodiment, a thickness H6 of the fourth transparent conductive film 256 is about 300 nm.

In this embodiment, after the fourth transparent conductive film 256 is formed on the second mesh conductive structure 254, then Step S108 is performed to form an ion storage layer 160 onto the fourth transparent conductive film 256 (as shown in FIG. 3G) to produce a second electrode structure B2 of FIG. 1, in which a thickness of the ion storage layer 160 is about 130 nm. In this embodiment, the electrochromic anode material for the ion storage layer 160 is Prussian blue, which can match well with the WO₃ or MoO₃ in the electrochromic cathode material of the electrochromic layer 130. The foregoing well matching stands for a higher variation rate in optical transmittance, better service reliability of the device, a higher discoloration rate and higher color contrast. In one embodiment, a spin coating process is applied to shake and spin a mixture of Fe(NO₃)₃ 9H₂O+Na4[Fe(CN)₆]10H₂O) for producing an Fe—HCF core, then a surface treating agent is added into the Fe—HCF core, and the mixture of the Fe—HCF core and the surface treating agent is stirred and dried to form water-dissoluble nanoparticles of Prussian blue. The nanoparticles of Prussian blue can be then coated on the fourth transparent conductive film 256.

After the aforesaid first electrode structure A2 and second electrode structure B2 are formed, then Step S109 is performed to bind together the first electrode structure A2 and the second electrode structure B2 by having the electrochromic layer 130 of the first electrode structure A2 to face the ion storage layer 160 of the second electrode structure B2, as shown in FIG. 3I. In detailing this step, the first electrode structure A2 is firstly turned upside down so as to have the electrochromic layer 130 of the first electrode structure A2 to face the ion storage layer 160 of the second electrode structure B2, and then the electrochromic layer 130 of the first electrode structure A2 and the ion storage layer 160 of the second electrode structure B2 are bound together via an adhesive component 180 such as an adhesive or a tape. The adhesive component 180 itself provides a thickness D2 to separate the electrochromic layer 130 from the ion storage layer 160, such that a fill-up space G2 can be formed between the electrochromic layer 130 and the ion storage layer 160. Finally, an electrolyte substance is injected to fill the fill-up space G2 so as to form the electrolyte layer 170 of FIG. 1. Then, in Step 110, the electrochromic device 200 is formed, and the electrolyte layer 170 therein has a thickness of 2 um.

Under such an arrangement, since the electrochromic layer 130 is mainly made by high melting point targets, in comparison with the conventional electrochromic layer 130 produced by the magnetron plasma splutter, the method for fabricating the electrochromic device S100 provided by this disclosure introduces the arc-plasma process to deposit the electrochromic layer 130. In comparison to 5% in the ionization rate of plating material for conventional splutters, the ionization rate of plating material for the arc-plasma process can be lifted up to a range of 65˜90%. with the boosting in the ionization rate of plating material, the process time can be shortened, the production cost can be reduced, and the properties of the electrochromic layer 130 can be improved by strengthening the voltage endurance, increasing the color-changing efficiency, and prolonging the service life.

Besides, since the electrochromic anode material of the aforesaid embodiment is Prussian blue (PB), which matches well with the electrochromic cathode material of the electrochromic layer 130, thus better optical performance, higher coloring efficiency and a rapid response rate can be obtained.

In summary, the electrochromic device and the method for fabricating the same electrochromic device provided by this disclosure, which apply the arc-plasma process to deposit the electrodes of the electrochromic layers, can reduce both the process time and production cost, strengthen the voltage endurance, have better color-changing efficiency, and extend the service life.

Further, the Prussian blue (PB) adopted in this disclosure is used for the electrochromic anode material, in which Prussian blue (PB) matches well withvWO₃ or MoO₃ in the electrochromic cathode material of the electrochromic layer so as to achieve better optical performance, higher coloring efficiency and a rapid response rate.

In addition, the transparent conductive layer of this disclosure is formed by a three-layer lamination structure having upper and lower transparent conductive films to sandwich a mesh conductive structure. The mesh conductive structure is formed by a plurality of silver-made conductive wires arranged into a specific pattern. Through the conductive wires, the electrode transmission can be performed. Since these conductive wires do not occupy the entire space between the upper and the lower transparent conductive films. In other words, the conductive wires do not utilize the entire area for transmission, but utilize the aforesaid small transmission units formed by arranging the conductive wires. Thereupon, the unexpected high transverse impedance of the electron transport layer (i.e., the transparent conductive layer) can be resolved, and also shortcomings in uneven color-changing and elongated reaction time during the transmission at the entire transparent conductive layer can be substantially improved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An method for fabricating an electrochromic device, comprising the steps of:
(a) depositing a first transparent conductive film on a first substrate;
(b) depositing a first mesh conductive structure on the first transparent conductive film;
(c) depositing a second transparent conductive film on the first mesh conductive structure;
(d) depositing an electrochromic layer on the second transparent conductive film by an arc-plasma process to form a first electrode structure, the electrochromic layer being made of one of WO₃ and MoO₃;
(e) depositing a third transparent conductive film on a second substrate;
(f) depositing a second mesh conductive structure on the third transparent conductive film;
(g) depositing a fourth transparent conductive film on the second mesh conductive structure;
(h) forming an ion storage layer on the fourth transparent conductive film to produce a second electrode structure, the ion storage layer being made of Prussian blue;
(i) binding together the first electrode structure and the second electrode structure by having the electrochromic layer of the first electrode structure to match the ion storage layer of the second electrode structure; and
(j) forming an electrolyte layer between the electrochromic layer and the ion storage layer so as to produce the electrochromic device.

2. The method for fabricating an electrochromic device of claim 1, wherein the step (b) includes the steps of:
(b1) providing a metal mask onto the first transparent conductive film, the metal mask having a plurality of opening structures; and
(b2) spluttering the metal material onto the metal mask and the first transparent conductive film so as to deposit the metal material into the opening structures for forming the first mesh conductive structure.

3. The method for fabricating an electrochromic device of claim 1, wherein the step (f) includes the steps of:
(f1) providing a metal mask onto the third transparent conductive film, the metal mask having a plurality of opening structures; and
(f2) spluttering the metal material onto the metal mask and the third transparent conductive film so as to deposit the metal material into the opening structures for forming the second mesh conductive structure.

4. The method for fabricating an electrochromic device of claim 1, wherein the step (h) includes a step (h1) of applying a spin coating process to coat a material of the ion storage layer over the fourth transparent conductive film.

5. The method for fabricating an electrochromic device of claim 1, wherein the step (i) includes a step (i1) of turning the first electrode structure upside down so as to have the electrochromic layer of the first electrode structure to face the ion storage layer of the second electrode structure.

6. The method for fabricating an electrochromic device of claim 1, wherein the step (j) includes the steps of:
(j1) binding together the electrochromic layer of the first electrode structure and the ion storage layer of the second electrode structure by producing a fill-up space between the electrochromic layer and the ion storage layer; and
(j2) filling an electrolyte substance into the fill-up space so as to form the electrolyte layer.

7. An electrochromic device, comprising:
a first electrode structure, including a first substrate, a first transparent conductive film, a first mesh conductive structure, a second transparent conductive film and an electrochromic layer; wherein the first transparent conductive film is disposed between the first substrate and the first mesh conductive structure, the first mesh conductive structure is disposed between the first transparent conductive film and the second transparent conductive film, the second transparent conductive film is disposed between the first mesh conductive structure and the electrochromic layer, the first mesh conductive structure includes a plurality of first conductive wires is disposed between the first transparent conductive film and the second transparent conductive film, the electrochromic layer is disposed on the second transparent conductive film, and the electrochromic layer is made of WO₃ or MoO₃;
a second electrode structure, includes a second substrate, a third transparent conductive film, a second mesh conductive structure, a fourth transparent conductive film and a ion storage layer; wherein the third transparent conductive film is disposed between the second substrate and the second mesh conductive structure, the second mesh conductive structure is disposed between the third transparent conductive film and the fourth transparent conductive film, the fourth transparent conductive film is disposed between the second mesh conductive structure and the ion storage layer, and the ion storage layer is made of Prussian blue; and
an electrolyte layer, disposed between the electrochromic layer of the first electrode structure and the ion storage layer of the second electrode structure.

8. The electrochromic device of claim 7, wherein each of the first conductive wires is made of silver.

9. The electrochromic device of claim 7, wherein the first mesh conductive structure includes a mesh structure formed by arranging the plurality of first conductive wires.

10. The electrochromic device of claim 7, wherein each of the second conductive wires is made of silver.

11. The electrochromic device of claim 7, wherein the second mesh conductive structure includes a mesh structure forming by arranging the plurality of second conductive wires.
